(19) United States
(12) Patent Application Publication
(10) Pub. No.: US 2026/0112634 A1
(43) Pub. Date: Apr. 23, 2026

(54) SECONDARY BATTERY

(71) Applicant: MURATA MANUFACTURING CO., LTD., Kyoto (JP)

(72) Inventor: Takumi HIASA, Kyoto (JP)

(21) Appl. No.: 19/429,071

(22) Filed: Dec. 22, 2025

Related U.S. Application Data
(63) Continuation of application No. PCT/JP2024/028537, filed on Aug. 8, 2024.

(30) Foreign Application Priority Data
Aug. 8, 2023 (JP) 2023-129547

(51) Int. Cl. H01M 4/62; H01M 4/02; H01M 4/505; H01M 4/58; H01M 4/66; H01M 10/38

(52) U.S. Cl. CPC H01M 4/622; H01M 4/505; H01M 4/5825; H01M 4/625; H01M 4/661; H01M 10/38; H01M 2004/021; H01M 2004/028

(57) ABSTRACT

A secondary battery includes a positive electrode, a negative electrode, and an electrolytic solution. The positive electrode includes a positive electrode active material layer. The electrolytic solution includes an aqueous solvent. The positive electrode active material layer includes a positive electrode active material and a positive electrode binder. The positive electrode active material includes a lithium-containing compound which a lithium ion is to be inserted into and extracted from. The positive electrode binder includes a polymer compound. The polymer compound includes a repeating unit represented by Formula (1), a repeating unit represented by Formula (2), or both. A solubility of the polymer compound in 100 g of water is less than or equal to 1 g. A ratio of a volume density of the positive electrode active material layer to a true density of the positive electrode active material is greater than or equal to 30% and less than or equal to 70%.

### CROSS REFERENCE TO RELATED APPLICATIONS

The present application is a continuation of International Application No. PCT/JP2024/028537, filed on Aug. 8, 2024, which claims priority to Japanese Patent Application No. 2023-129547, filed on Aug. 8, 2023, the entire contents of which are incorporated herein by reference.

### BACKGROUND

The present technology relates to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and an aqueous electrolytic solution. The aqueous electrolytic solution is an electrolytic solution including an aqueous solvent. A configuration of the secondary battery including the aqueous electrolytic solution has been considered in various ways.

For example, an acetal resin or an acrylic resin is used as a constituent material of an electrode. In this case, for example, a solubility parameter and a void rate of the electrode are defined.

### SUMMARY

The present technology relates to a secondary battery.

Although consideration has been given in various ways regarding a configuration of a secondary battery including an aqueous electrolytic solution, a battery characteristic of the secondary battery is not sufficient yet. Accordingly, there is room for improvement in terms of the battery characteristic of the secondary battery.

It is desirable to provide a secondary battery that makes it possible to achieve a superior battery characteristic.

A secondary battery according to an embodiment of the present technology includes a positive electrode, a negative electrode, and an electrolytic solution. The positive electrode includes a positive electrode active material layer. The electrolytic solution includes an aqueous solvent. The positive electrode active material layer includes a positive electrode active material and a positive electrode binder. The positive electrode active material includes a lithium-containing compound which a lithium ion is to be inserted into and extracted from. The positive electrode binder includes a polymer compound. The polymer compound includes a repeating unit represented by Formula (1), a repeating unit represented by Formula (2), or both. A solubility of the polymer compound in 100 g of water is less than or equal to 1 g. A ratio of a volume density of the positive electrode active material layer to a true density of the positive electrode active material is greater than or equal to 30% and less than or equal to 70%.

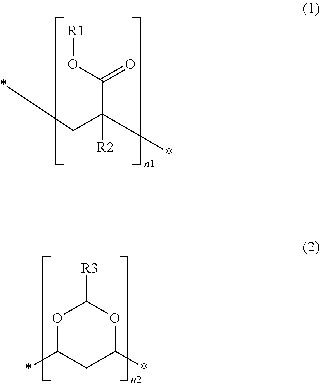

where:
R1 is either a hydrocarbon group or an oxygen-containing hydrocarbon group;
R2 is either a hydrogen group or a hydrocarbon group;
R3 is either a hydrocarbon group or an oxygen-containing hydrocarbon group;
each of n1 and n2 is an integer of 2 or greater; and
an asterisk (*) represents a dangling bond.

According to the secondary battery of an embodiment of the present technology, the positive electrode active material layer includes the positive electrode active material and the positive electrode binder. The electrolytic solution includes the aqueous solvent. The positive electrode active material includes the lithium-containing compound which the lithium ion is to be inserted into and extracted from. The positive electrode binder includes the polymer compound. The polymer compound includes the repeating unit represented by Formula (1), the repeating unit represented by Formula (2), or both. The solubility of the polymer compound in 100 g of water is less than or equal to 1 g. The ratio of the volume density of the positive electrode active material layer to the true density of the positive electrode active material is greater than or equal to 30% and less than or equal to 70%. Accordingly, it is possible to achieve a superior battery characteristic.

Note that effects of the present technology are not necessarily limited to those described herein and may include any of a series of effects in relation to the present technology.

### BRIEF DESCRIPTION OF THE FIGURES

FIG. 1 is a sectional diagram illustrating a configuration of a secondary battery according to an embodiment of the present technology.

FIG. 2 is a sectional diagram illustrating a configuration of a secondary battery according to an embodiment of the present technology.

FIG. 3 is a sectional diagram illustrating a configuration of a secondary battery according toan embodiment.

FIG. 4 is a sectional diagram illustrating a configuration of a secondary battery according to an embodiment.

### DETAILED DESCRIPTION

The present technology is described below in further detail including with reference to the drawings according to an embodiment.

A description is given first of a secondary battery according to a first embodiment of the present technology.

The secondary battery to be described here is a secondary battery that causes charging and discharging reactions to proceed through insertion and extraction of a lithium ion into and from a positive electrode. The secondary battery is what is called a lithium-ion secondary battery.

The secondary battery includes a positive electrode, a negative electrode, and an aqueous electrolytic solution. The aqueous electrolytic solution is a liquid electrolyte. More specifically, the aqueous electrolytic solution is an electrolytic solution including an aqueous solvent, as described above.

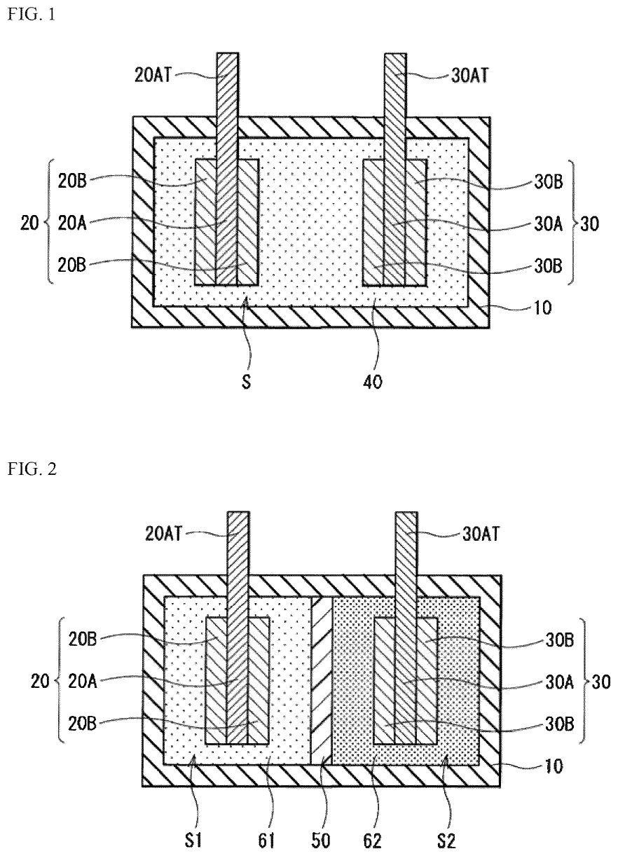

FIG. 1 illustrates a sectional configuration of the secondary battery according to the first embodiment. As illustrated in FIG. 1, the secondary battery includes an outer package body 10, a positive electrode 20, a negative electrode 30, and an electrolytic solution 40. In FIG. 1, the electrolytic solution 40 is lightly shaded.

The secondary battery according to the first embodiment is a secondary battery of what is called a one-component type, because the secondary battery includes one aqueous electrolytic solution (the electrolytic solution 40).

As illustrated in FIG. 1, the outer package body 10 is a substantially box-shaped outer package member for containing components including, without limitation, the positive electrode 20, the negative electrode 30, and the electrolytic solution 40, and has an internal space S.

The outer package body 10 includes any one or more of materials including, without limitation, a metal material, a glass material, and a polymer compound. Note that the outer package body 10 may be, but not limited to, a rigid metal can, a rigid glass case, a rigid plastic case, a soft or flexible metal foil, or a soft or flexible polymer film.

As illustrated in FIG. 1, the positive electrode 20 is disposed in the internal space S, and allows the lithium ion to be inserted thereinto and extracted therefrom. Here, the positive electrode 20 includes a positive electrode current collector 20A and a positive electrode active material layer 20B.

Note that the positive electrode current collector 20A may be omitted. That is, the positive electrode 20 may not include the positive electrode current collector 20A, and may thus include only the positive electrode active material layer 20B.

The positive electrode current collector 20A is an electrically conductive support member that supports the positive electrode active material layer 20B, and has two opposed surfaces that support the positive electrode active material layer 20B. The positive electrode current collector 20A includes any one or more of electrically conductive materials including, without limitation, a metal material, a carbon material, and an electrically conductive ceramic material. Specific examples of the metal material include titanium, nickel, aluminum, and an alloy of each thereof. Specific examples of the electrically conductive ceramic material include indium tin oxide (ITO).

The positive electrode current collector 20A preferably includes a material that is insoluble or sparingly soluble in and resistant to corrosion by the electrolytic solution 40, and that has low reactivity to a positive electrode active material to be described later. Therefore, the positive electrode current collector 20A preferably includes the metal material. One reason for this is that this suppresses degradation of the positive electrode current collector 20A upon charging and discharging.

In particular, the positive electrode current collector 20A preferably includes titanium as a constituent element, and more preferably includes titanium. One reason for this is that this further suppresses degradation of the positive electrode current collector 20A upon charging and discharging.

Note that the positive electrode current collector 20A may be an electric conductor having a surface covered with plating of any of the above-described electrically conductive materials. The material included in the electrical conductor is not particularly limited, and may thus be selected as desired.

Here, the positive electrode current collector 20A includes a coupling terminal part 20AT on which the positive electrode active material layer 20B is not provided, and the coupling terminal part 20AT is led from an inside (the internal space S) to an outside of the outer package body 10.

The positive electrode active material layer 20B is a layer which the lithium ion is to be inserted into and extracted from. Here, the positive electrode active material layer 20B is provided on each of the two opposed surfaces of the positive electrode current collector 20A. Note that the positive electrode active material layer 20B may be provided only on one of the two opposed surfaces of the positive electrode current collector 20A on a side where the positive electrode 20 is opposed to the negative electrode 30.

The positive electrode active material layer 20B includes a positive electrode active material and a positive electrode binder. Note that the positive electrode active material layer 20B may further include any one or more of materials including, without limitation, a positive electrode conductor. A detailed configuration of the positive electrode active material layer 20 will be described later.

As illustrated in FIG. 1, the negative electrode 30 is disposed in the internal space S, and allows a cation such as the lithium ion to be inserted thereinto and extracted therefrom. Here, the negative electrode 30 includes a negative electrode current collector 30A and a negative electrode active material layer 30B.

Note that the negative electrode current collector 30A may be omitted. That is, the negative electrode 30 may not include the negative electrode current collector 30A, and may thus include only the negative electrode active material layer 30B.

The negative electrode current collector 30A is an electrically conductive support member that supports the negative electrode active material layer 30B, and has two opposed surfaces that support the negative electrode active material layer 30B. The negative electrode current collector 30A includes any one or more of electrically conductive materials including, without limitation, a metal material, a carbon material, and an electrically conductive ceramic material.

Specific examples of the metal material include stainless steel (SUS), titanium, zinc, tin, lead, and an alloy of each thereof. The stainless steel may be highly corrosion-resistant stainless steel that includes any one or more of additive elements including, without limitation, niobium and molybdenum added thereto. Specifically, the stainless steel may be, for example, SUS444 including molybdenum added thereto as an additive element. Details of the electrically conductive ceramic material are as described above.

The negative electrode current collector 30A preferably includes a material that is insoluble or sparingly soluble in and resistant to corrosion by the electrolytic solution 40, and that has low reactivity to a negative electrode active material to be described later. Therefore, the negative electrode current collector 30A preferably includes the metal material. One reason for this is that this suppresses degradation of the negative electrode current collector 30A upon charging and discharging.

Note that the negative electrode current collector 30A may be an electric conductor having a surface covered with plating of any of the above-described electrically conductive materials. The material included in the electrical conductor is not particularly limited, and may thus be selected as desired.

Here, the negative electrode current collector 30A includes a coupling terminal part 30AT on which the negative electrode active material layer 30B is not provided, and the coupling terminal part 30AT is led from the inside (the internal space S) to the outside of the outer package body 10.

The negative electrode active material layer 30B is a layer which a cation such as the lithium ion is to be inserted into and extracted from. Here, the negative electrode active material layer 30B is provided on each of the two opposed surfaces of the negative electrode current collector 30A. Note that the negative electrode active material layer 30B may be provided only on one of the two opposed surfaces of the negative electrode current collector 30A on a side where the negative electrode 30 is opposed to the positive electrode 20.

The negative electrode active material layer 30B may include any one or more of negative electrode active materials which the lithium ion is to be inserted into and extracted from. Note that the negative electrode active material layer 30B may further include any one or more of materials including, without limitation, a negative electrode binder and a negative electrode conductor.

Specific examples of the negative electrode active material which the lithium ion is to be inserted into and extracted from include titanium oxide, a carbon material, and a metal-based material. Specific examples of titanium oxide include anatase-type titanium oxide, rutile-type titanium oxide, and brookite-type titanium oxide. Specific examples of the carbon material include graphite. The metal-based material is a material including, as one or more constituent elements, any one or more of metal elements and metalloid elements that are each able to form an alloy with lithium.

Alternatively, the negative electrode active material layer 30B may include any one or more of other negative electrode active materials which a cation other than the lithium ion is to be inserted into and extracted from, instead of the negative electrode active materials which the lithium ion is to be inserted into and extracted from. The kinds of cations other than the lithium ion may be only one in number, or may be two or more in number.

Specific examples of the other negative electrode active material which the cation other than the lithium ion is to be inserted into and extracted from include a titanium-containing compound, a niobium-containing compound, a vanadium-containing compound, an iron-containing compound, a molybdenum-containing compound, and zinc.

Examples of the titanium-containing compound include an alkali metal-titanium composite oxide and a titanium-phosphorus oxide. Examples of the alkali metal-titanium composite oxide include a potassium-titanium composite oxide. Specific examples of the potassium-titanium composite oxide include K₂Ti₃O₇ and K₄Ti₅O₁₂. Specific examples of the titanium-phosphorus oxide include TiP₂O₇ and NaTi₂(PO₄)₃.

Examples of the niobium-containing compound include a hydrogen-niobium compound and a titanium-niobium composite oxide. Specific examples of the hydrogen-niobium compound include H₄Nb₆O₁₇. Specific examples of the titanium-niobium composite oxide include TiNb₂O₇ and Ti₂Nb₁₀O₂₉.

Examples of the vanadium-containing compound include a vanadium oxide. Specific examples of the vanadium oxide include vanadium dioxide (VO₂).

Examples of the iron-containing compound include an iron hydroxide. Specific examples of the iron hydroxide include iron oxyhydroxide (FeOOH).

Examples of the molybdenum-containing compound include a molybdenum oxide and a cobalt-molybdenum composite oxide. Specific examples of the molybdenum oxide include molybdenum dioxide (MoO₂). Specific examples of the cobalt-molybdenum composite oxide include CoMoO₄.

It goes without saying that the negative electrode active material layer 30B may include any one or more of the negative electrode active materials which the lithium ion is to be inserted into and extracted and also include any one or more of the other negative electrode active materials which the cation other than the lithium ion is to be inserted into and extracted from.

The electrolytic solution 40 is contained in the internal space S, and is an aqueous electrolytic solution as described above. In other words, the electrolytic solution 40 is a solution in which an ionizable ionic material is dissolved or dispersed in an aqueous solvent.

The electrolytic solution 40 includes the aqueous solvent and any one or more of ionic materials that are ionizable in the aqueous solvent. More specifically, the electrolytic solution 40 included in the secondary battery includes the lithium ion that is to be inserted into and extracted from the positive electrode 20.

The aqueous solvent is not particularly limited in kind, and specific examples thereof include pure water. The ionic material is not particularly limited in kind, and specifically includes any one or more of materials including, without limitation, an acid, a base, and an electrolyte salt. Specific examples of the acid include carbonic acid, oxalic acid, nitric acid, sulfuric acid, hydrochloric acid, acetic acid, and citric acid.

The electrolyte salt is a salt including a cation and an anion. Specifically, the electrolyte salt includes any one or more of lithium salts. The lithium salts each include the lithium ion as the cation.

The anion is not particularly limited in kind. In particular, the anion preferably includes, as one or more anions, any one or more of ions including, without limitation, a sulfuric acid ion, a hydrogen sulfuric acid ion, a carbonic acid ion, a hydrogen carbonic acid ion, a phosphoric acid ion, a monohydrogen phosphoric acid ion, a dihydrogen phosphoric acid ion, and a carboxylic acid ion. One reason for this is that this sufficiently suppresses variation in pH of the electrolytic solution 40. Specific examples of the carboxylic acid ion include a formic acid ion, an acetic acid ion, a propionic acid ion, a tartaric acid ion, and a citric acid ion.

In particular, it is preferable that the electrolytic solution 40 included in the secondary battery of the one-component type have a pH lower than 11. Specifically, the pH of the electrolytic solution 40 is preferably within a range from 3 to 8 both inclusive, more preferably within a range from 4 to 8 both inclusive, and still more preferably within a range from 4 to 6 both inclusive. One reason for this is that this makes it easier for the charging and discharging reactions to proceed in the positive electrode 20. Another reason for this is that this suppresses corrosion of component members of the secondary battery including, without limitation, the outer package body 10 and the positive electrode current collector 20A, therefore improving electrochemical durability or stability of the secondary battery.

A content of the ionic material, i.e., a concentration (mol/kg) of the electrolytic solution 40, is not particularly limited, and may thus be set as desired. Specifically, the concentration of the electrolytic solution 40 is preferably within a range from 0.01 mol/kg to 10 mol/kg both inclusive, and more preferably within a range from 0.2 mol/kg to 4 mol/kg both inclusive. One reason for this is that this makes it easier for the charging and discharging reactions to proceed stably in the positive electrode 20 in the electrolytic solution 40.

Note that the electrolyte salt may further include any one or more of other metal salts in addition to the above-described lithium salt. The other metal salt is not particularly limited in kind, and specific examples thereof include an alkali metal salt (excluding the lithium salt), an alkaline earth metal salt, and a transition metal salt. Specific examples of the alkali metal salt include a sodium salt and a potassium salt. Specific examples of the alkaline earth metal salt include a calcium salt and a magnesium salt.

It is preferable that the electrolytic solution 40 be a saturated solution of the electrolyte salt. One reason for this is that this facilitates stable insertion and extraction of the lithium ion upon charging and discharging, which makes it easier for the charging and discharging reactions to proceed stably.

In order to check whether the electrolytic solution 40 is the saturated solution of the electrolyte salt, the secondary battery may be disassembled, following which the internal space S may be visually observed to thereby check whether the electrolyte salt is deposited. In this case, for example, a location in the electrolytic solution 40, a location on a surface of the positive electrode 20, and a location on an inner wall surface of the outer package body 10 are observed visually. If the electrolyte salt is deposited and the electrolytic solution 40, which is a liquid, and the deposited matter of the electrolyte salt, which is a solid, therefore coexist, it is conceivable that the electrolytic solution 40 is a saturated solution of the electrolyte salt. In order to examine a composition of the deposited matter, a surface analysis method such as X-ray photoelectron spectroscopy (XPS) is usable, or a composition analysis method such as inductively coupled plasma (ICP) optical emission spectroscopy is usable.

Further, the electrolytic solution 40 may be a pH buffer solution. The pH buffer solution may be an aqueous solution in which a weak acid and a conjugate base thereof are mixed together, or an aqueous solution in which a weak base and a conjugate acid thereof are mixed together. One reason for this is that this sufficiently suppresses variation in pH of the electrolytic solution 40.

In addition, the electrolytic solution 40 may further include any one or more of buffers. Specific of the buffer include tris(hydroxymethyl)aminomethane and ethylenediaminetetraacetic acid.

The positive electrode active material layer 20B includes the positive electrode active material and the positive electrode binder, and may further include the positive electrode conductor, as described above.

The positive electrode active material is a material which the lithium ion is to be inserted into and extracted from. More specifically, the positive electrode active material includes any one or more of lithium-containing compounds which the lithium ion is to be inserted into and extracted from. The term “lithium-containing compound” is a generic term for a compound including lithium as a constituent element.

The lithium-containing compound is not particularly limited in kind, and specific examples thereof include a lithium composite oxide and a lithium phosphoric acid compound. The lithium composite oxide is an oxide including lithium and any one or more of transition metal elements as constituent elements, and has a layered rock-salt crystal structure or a spinel crystal structure. The lithium phosphoric acid compound is a phosphoric acid compound including lithium and any one or more of transition metal elements as constituent elements, and has an olivine crystal structure. The transition metal elements are not particularly limited in kind, and specific examples thereof include nickel, cobalt, manganese, and iron.

Specific examples of the lithium composite oxide having the layered rock-salt crystal structure include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, and Li_{1.15}(Mn_{0.65}Ni_{0.22}Co_{0.13}) O₂. Specific examples of the lithium composite oxide having the spinel crystal structure include LiMn₂O₄. Specific examples of the lithium phosphoric acid compound having the olivine crystal structure include LiFePO₄, LiMnPO₄, LiMn_{0.5}Fe_{0.5}PO₄, LiMn_{0.7}Fe_{0.3}PO₄, and LiMn_{0.75}Fe_{0.25}PO₄.

In particular, it is preferable that the lithium-containing compound include the lithium composite oxide, and the lithium composite oxide have the spinel crystal structure and include manganese as a constituent element. One reason for this is that this improves charging efficiency and also improves discharging efficiency. Specific examples of the lithium composite oxide described here include LiMn₂O₄, as described above.

Alternatively, it is preferable that the lithium-containing compound include the lithium phosphoric acid compound, and the lithium phosphoric acid compound have the olivine crystal structure and include iron as a constituent element. One reason for this is that this improves the charging efficiency and also improves the discharging efficiency. Specific examples of the lithium phosphoric acid compound described here include LiFePO₄, LiMn_{0.5}Fe_{0.5}PO₄, LiMn_{0.7}Fe_{0.3}PO₄, and LiMn_{0.75}Fe_{0.25}PO₄, as described above.

The positive electrode binder is a material that bonds, for example, the positive electrode active material, and includes any one or more of polymer compounds that have a polarity and are hardly soluble in water. The polymer compound that has a polarity and is hardly soluble in water is hereinafter referred to as a “water-insoluble polar polymer compound”.

Specifically, the water-insoluble polar polymer compound includes a repeating unit represented by Formula (1), a repeating unit represented by Formula (2), or both.

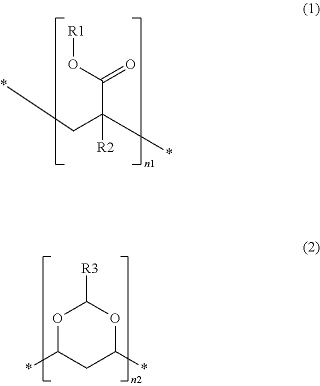

where:
R1 is either a hydrocarbon group or an oxygen-containing hydrocarbon group;
R2 is either a hydrogen group or a hydrocarbon group;
R3 is either a hydrocarbon group or an oxygen-containing hydrocarbon group;
each of n1 and n2 is an integer of 2 or greater; and
an asterisk (*) represents a dangling bond.

Some reasons why the positive electrode binder includes the water-insoluble polar polymer compound are as described below. A first reason is that this secures a binding property of, for example, the positive electrode active material including the positive electrode binder, therefore making it easier to maintain a structure of the positive electrode active material layer 20B upon charging and discharging. A second reason is that this secures insertability and extractability of the lithium ion in the positive electrode active material layer 20B even when the electrolytic solution 40 that is an aqueous electrolytic solution is used, therefore making it easier for the charging and discharging reactions to proceed stably in the positive electrode active material layer 20B.

Hereinafter, the repeating unit represented by Formula (1) is referred to as a “first repeating unit”, and the repeating unit represented by Formula (2) is referred to as a “second repeating unit”. The water-insoluble polar polymer compound may include only the first repeating unit, may include only the second repeating unit, or may include both the first repeating unit and the second repeating unit, as described above.

The first repeating unit has a polyacrylic acid ester structure, as indicated by Formula (1). As described above, the asterisk (*) represents a dangling bond. The first repeating unit is therefore a divalent group having two dangling bonds.

R1 is not particularly limited in kind as long as R1 is either the hydrocarbon group or the oxygen-containing hydrocarbon group, as described above.

The term “hydrocarbon group” for R1 is a generic term for a monovalent group including carbon and hydrogen, and the hydrocarbon group is not particularly limited in carbon number. The hydrocarbon group is not particularly limited in kind, and specific examples thereof include an alkyl group, an alkenyl group, an alkynyl group, an aryl group, and a cycloalkyl group. Note that the alkyl group, the alkenyl group, and the alkynyl group may each have a straight-chain structure, or may have a branched structure.

Specific examples of the alkyl group include a methyl group, an ethyl group, a propyl group, a butyl group, a pentyl group, a hexyl group, a heptyl group, an octyl group, a nonyl group, and a decyl group. Specific examples of the alkenyl group include a vinyl group and an allyl group. Specific examples of the alkynyl group include an ethynyl group and a propargyl group. Specific examples of the aryl group include a phenyl group and a naphthyl group. Specific examples of the cycloalkyl group include a cyclopropyl group, a cyclobutyl group, a cyclopentyl group, and a cyclohexyl group.

The term “oxygen-containing hydrocarbon group” is a generic term for a monovalent group corresponding to the above-described hydrocarbon group into which one or more ether bonds (—O—) are introduced, and positions where the one or more ether bonds (—O—) are introduced into the hydrocarbon group are not particularly limited.

Specific examples of the oxygen-containing hydrocarbon group when the hydrocarbon group is a straight-chain propyl group (—CH₂—CH₂—CH₃) having carbon number of 3 are as described below.

Examples of the oxygen-containing hydrocarbon group including one ether bond include —O—CH₂—CH₂—CH₃, —CH₂—O—CH₂—CH₃, and —CH₂—CH₂—O—CH₃. Examples of the oxygen-containing hydrocarbon group including two ether bonds include —O—CH₂—O—CH₂—CH₃, —O—CH₂—CH₂—O—CH₃, and —CH₂—O—CH₂—O—CH₃. Examples of the oxygen-containing hydrocarbon group including three ether bonds include —O—CH₂—O—CH₂—O—CH₃.

In particular, R1 is preferably an alkyl group having carbon number from 1 to 10 both inclusive. One reason for this is that this allows the water-insoluble polar polymer compound to have sufficient solubility and sufficient compatibility in a process of preparing a positive electrode mixture slurry to be described later, and allows the positive electrode active material layer 20B including the positive electrode mixture slurry to have a sufficient binding property.

R2 is not particularly limited in kind as long as R2 is either the hydrogen group or the hydrocarbon group. Details of the hydrocarbon group are as described above. R2 and R1 may be the same as each other in kind, or may be different from each other in kind.

In particular, R2 is preferably an alkyl group having carbon number of 1 or 2. One reason for this is that this allows the water-insoluble polar polymer compound to have sufficient solubility and sufficient compatibility in the process of preparing the positive electrode mixture slurry to be described later, and allows the positive electrode active material layer 20B including the positive electrode mixture slurry to have a sufficient binding property.

The second repeating unit has a polyvinyl butyral structure, as indicated by Formula (2). As described above, the asterisk (*) represents a dangling bond. The second repeating unit is therefore a divalent group having two dangling bonds.

R3 is not particularly limited in kind as long as R3 is either the hydrocarbon group or the oxygen-containing hydrocarbon group, as described above. Details of each of the hydrocarbon group and the oxygen-containing hydrocarbon group are as described above.

In particular, R3 is preferably an alkyl group having carbon number from 1 to 10 both inclusive. One reason for this is that this allows the water-insoluble polar polymer compound to have sufficient solubility and sufficient compatibility in the process of preparing the positive electrode mixture slurry to be described later, and allows the positive electrode active material layer 20B including the positive electrode mixture slurry to have a sufficient binding property.

Each of the first repeating unit and the second repeating unit has two dangling bonds, as described above. The water-insoluble polar polymer compound therefore has a dangling bonds at each of both ends, i.e., two dangling bonds.

A monovalent group bonded to each of the two dangling bonds is hereinafter referred to as an “end group”. The water-insoluble polar polymer compound therefore has two end groups. One end group and another end group may be the same as each other in kind, or may be different from each other in kind.

The end group is not particularly limited in kind, and is specifically any one of a hydrogen group, a hydrocarbon group, or an oxygen-containing hydrocarbon group. Details of each of the hydrocarbon group and the oxygen-containing hydrocarbon group are as described above.

The water-insoluble polar polymer compound is hardly soluble in water, as described above. A solubility of the water-insoluble polar polymer compound in 100 g of water is therefore sufficiently small. The solubility of the water-insoluble polar polymer compound in 100 g of water is hereinafter referred to as “water solubility”. The “water” described here is what is called pure water.

Specifically, the water solubility is less than or equal to 1 g. One reason for this is that this secures the binding property of, for example, the positive electrode active material including the positive electrode binder, therefore securing physical strength of the positive electrode active material layer 20B. This makes it easier to maintain the structure of the positive electrode active material layer 20B even upon repeated charging and discharging, therefore facilitating stable and continuous insertion and extraction of the lithium ion into and from the positive electrode active material layer 20B.

A procedure for measuring the water solubility is as described below. A description is given below of a case where the positive electrode active material layer 20B includes the positive electrode active material, the positive electrode binder, and the positive electrode conductor.

First, the secondary battery is disassembled to thereby take out the positive electrode 20. Thereafter, the positive electrode 20 is immersed in an organic solvent, following which the organic solvent is stirred.

The organic solvent is not particularly limited in kind as long as the organic solvent includes any one or more of organic solvents in which the positive electrode binder is dissolvable. Specific examples of the organic solvent include N-methyl-2-pyrrolidone, toluene, butyl acetate, ethanol, and terpineol.

Thus, the positive electrode binder that is a soluble component is dissolved in the organic solvent, and the positive electrode active material and the positive electrode conductor that are insoluble components are precipitated.

Thereafter, the organic solvent is filtered, following which a resultant filtrate is dried. This allows the positive electrode active material and the positive electrode conductor to be separated from the positive electrode binder, and allows the positive electrode binder in a solid state to be taken out.

Lastly, an operation of putting a fixed amount of the positive electrode binder into a specified amount of water while stirring the specified amount of water is repeated to thereby visually check a dissolved state of the positive electrode binder. For example, the specified amount is 10 g, and the fixed amount is 10 mg.

Thus, the water solubility of the water-insoluble polar polymer compound that is the positive electrode binder is determined based on the amount (g) of the positive electrode binder put into water when a precipitate is formed because the positive electrode binder is no longer dissolved in water.

The water-insoluble polar polymer compound is not particularly limited in weight average molecular weight. In particular, the weight average molecular weight of the water-insoluble polar polymer compound is preferably within a range from 50,000 to 300,000 both inclusive. One reason for this is that this secures the binding property of, for example, the positive electrode active material including the positive electrode binder.

A procedure for measuring the weight average molecular weight is as described below. First, the positive electrode binder (the water-insoluble polar polymer compound) is taken out by a procedure similar to the above-described procedure for measuring the water solubility. Thereafter, the positive electrode binder is put into an aqueous solvent such as pure water, following which the aqueous solvent is stirred. The positive electrode binder is thereby dispersed in the aqueous solvent. As a result, a dispersion liquid is prepared. Lastly, the dispersion liquid is analyzed by a static light scattering method to thereby measure a molecular weight of the positive electrode binder included in the dispersion liquid. In this case, a particle size distribution analyzer (e.g., a laser diffraction/scattering particle size distribution analyzer Partica LA-960 available from HORIBA, Ltd.) is used as an analyzer. In addition, a scattered light intensity is measured using three dispersion liquids with respective concentrations set as desired to thereby determine the molecular weight of the positive electrode binder by a Debye plot method. As a result, the weight average molecular weight of the water-insoluble polymer compound is measured.

In the positive electrode active material layer 20B, a void volume included in the positive electrode active material layer 20B is made appropriate. In other words, a void rate in the positive electrode active material layer 20B is made appropriate.

Specifically, a density ratio, which is a ratio of a volume density (g/cm³) of the positive electrode active material layer 20B to a true density (g/cm³) of the positive electrode active material, is within a range from 30% to 70% both inclusive. One reason for this is that this makes it easier for the electrolytic solution 40 to permeate into the positive electrode active material layer 20B even when the electrolytic solution 40 that is an aqueous electrolytic solution is used. One reason for this is that this facilitates stable and continuous insertion and extraction of the lithium ion into and from the positive electrode active material layer 20B even upon repeated charging and discharging.

The density ratio is a physical value that influences the void rate in the positive electrode active material layer 20B described above, and is calculated based on the following calculation expression: density ratio=(volume density/true density)×100.

Note that, as will be described later, the volume density changes with change in compression-molding conditions for the positive electrode active material layer 20B in a manufacturing process of the positive electrode 20. The compression-molding conditions include a pressing pressure and a pressing time. The density ratio is therefore controllable to have a desired value by changing the volume density depending on the compression-molding conditions.

A procedure for measuring the density ratio is as described below. A description is given below of a case where the positive electrode active material layer 20B includes the positive electrode active material, the positive electrode binder, and the positive electrode conductor.

First, the secondary battery is disassembled to thereby take out the positive electrode 20. Thereafter, a weight and dimensions (a length, a width, and a thickness) of the positive electrode 20 are measured. Thereafter, the positive electrode 20 is immersed in an organic solvent, following which the organic solvent is stirred. Details of the organic solvent are as described above. This allows the positive electrode current collector 20A to be separated from the positive electrode active material layer 20B in the organic solvent, and therefore the positive electrode current collector 20A is taken out. In addition, the positive electrode binder that is a soluble component is dissolved in the organic solvent, and the positive electrode active material and the positive electrode conductor that are insoluble components are precipitated.

Thereafter, a weight and dimensions (a length, a width, and a thickness) of the positive electrode current collector 20A are measured. Thereafter, a weight and dimensions of the positive electrode active material layer 20B are calculated based on the weight and the dimensions of the positive electrode 20 and the weight and the dimensions of the positive electrode current collector 20A to thereby calculate the volume density of the positive electrode active material layer 20B.

Thereafter, the organic solvent is filtered, following which a resultant filtrate is dried. This allows a mixture, which is a solid content, of the positive electrode active material and the positive electrode conductor to be taken out. Thereafter, the mixture is heated at a heating temperature from 300° C. to 700° C. both inclusive in the atmosphere on an as-needed basis to thereby remove an organic substance remaining in the mixture. Thereafter, the mixture is centrifuged by a centrifugal separator to thereby take out the positive electrode active material from the mixture. Thereafter, the positive electrode active material is pulverized on an as-needed basis.

Thereafter, a method such as powder X-ray diffraction analysis is used to analyze the positive electrode active material (the lithium-containing compound) to thereby identify the crystal structure of the positive electrode active material, and measure a ratio of a transition metal element included at transition metal sites in the positive electrode active material.

Thereafter, the true density of the positive electrode active material is determined based on a result of analysis of the positive electrode active material, as will be described later.

When the lithium-containing compound is LiMn₂O₄ having the spinel crystal structure, the true density of the positive electrode active material is assumed to be 4.3 g/cm³. When the lithium-containing compound is LiFePO₄ having the olivine crystal structure, the true density of the positive electrode active material is assumed to be 3.6 g/cm³. When the lithium-containing compound is LiMnPO₄ having the olivine crystal structure, the true density of the positive electrode active material is assumed to be 3.4 g/cm³. When the lithium-containing compound is LiCoO₂ having the layered rock-salt crystal structure, the true density of the positive electrode active material is assumed to be 5.1 g/cm³.

When the lithium-containing compound is LiNiO₂ having the layered rock-salt crystal structure, the true density of the positive electrode active material is assumed to be 4.8 g/cm³. When the lithium-containing compound is a ternary compound having the layered rock-salt crystal structure, the true density of the positive electrode active material is assumed to be 4.6 g/cm³. The ternary compound is a composite oxide including nickel, manganese, and cobalt as constituent elements, and specific examples thereof include Li(Ni_{1/3}Mn_{1/3}Co_{1/3})O₂.

More specifically, when the crystal structure is primarily the spinel crystal structure, and a molar ratio of the transition metal element (manganese) included at the transition metal sites is greater than or equal to 50%, the lithium-containing compound is LiMn₂O₄, and therefore the true density of the positive electrode active material is 4.3 g/cm³, as described above. Note that when the molar ratio of manganese is greater than or equal to 50% although an element other than manganese is included at the transition metal sites, the true density is not particularly corrected and is assumed to be 4.3 g/cm³.

When the crystal structure is primarily the olivine crystal structure, and the molar ratio of the transition metal element (iron) included at the transition metal sites is greater than or equal to 50%, the lithium-containing compound is LiFePO₄, and therefore the true density of the positive electrode active material is 3.6 g/cm³, as described above. Note that when the molar ratio of iron is greater than or equal to 50% although an element other than iron is included at the transition metal sites, the true density is not particularly corrected and is assumed to be 3.6 g/cm³.

When the crystal structure is primarily the olivine crystal structure, and the molar ratio of the transition metal element (iron) included at the transition metal sites is less than 50% but the molar ratio of the transition metal element (manganese) included at the transition metal sites is greater than or equal to 50%, the lithium-containing compound is LiMnPO₄, and therefore the true density of the positive electrode active material is 3.4 g/cm³, as described above. Note that when the molar ratio of manganese is greater than or equal to 50% although an element other than manganese is included at the transition metal sites, the true density is not particularly corrected and is assumed to be 3.4 g/cm³.

When the crystal structure is primarily the layered rock-salt crystal structure, and the molar ratio of the transition metal element (cobalt) included at the transition metal sites is greater than or equal to 50% the lithium-containing compound is LiCoO₂, and therefore the true density of the positive electrode active material is 5.1 g/cm³, as described above. Note that when the molar ratio of cobalt is greater than or equal to 50% although an element other than cobalt is included at the transition metal sites, the true density is not particularly corrected and is assumed to be 5.1 g/cm³.

When the crystal structure is primarily the layered rock-salt crystal structure, and the molar ratio of each of the transition metals (cobalt and manganese) included at the transition metal sites is less than 50% but the molar ratio of nickel included at the transition metal sites is greater than or equal to 50%, the lithium-containing compound is LiNiO₂, and therefore the true density of the positive electrode active material is 4.8 g/cm³, as described above. Note that when the molar ratio of nickel is greater than or equal to 50% although an element other than nickel is included at the transition metal sites, the true density is not particularly corrected and is assumed to be 4.8 g/cm³.

When: the crystal structure is primarily the layered rock-salt crystal structure; the molar ratio of the transition metal (cobalt) included at the transition metal sites is less than 50%; and cobalt, nickel, and manganese are included at the transition metal sites, the lithium-containing compound is the ternary compound, and therefore the true density of the positive electrode active material is 4.6 g/cm³, as described above. Note that when cobalt, nickel, and manganese are included at the transition metal sites although an element other than cobalt, nickel, and manganese are included at the transition metal sites, the true density is not particularly corrected and is assumed to be 4.6 g/cm³.

Note that a total sum, i.e., a weighted average, of values of the true densities of the positive electrode active materials each multiplied by a content percentage of a corresponding one of the positive electrode active materials is adopted as a value of the true density when two or more positive electrode active materials are included. For example, a true density when lithium manganese oxide in a content percentage of 50 vol % and lithium iron phosphate in a content percentage of 50 vol % are included is assumed to be 3.9 g/cm³.

The true density of the positive electrode active material is thereby determined.

Lastly, the density ratio is calculated based on the volume density and the true density.

The positive electrode conductor is a material that improves electrical conductivity of the positive electrode active material layer 20B, and includes any one or more of electrically conductive materials. The electrically conductive material is not particularly limited in kind, and specific examples thereof include a carbon material, a metal material, an electrically conductive ceramic material, and an electrically conductive polymer compound.

In particular, the positive electrode conductor preferably includes the carbon material. One reason for this is that this sufficiently improves the electrical conductivity of the positive electrode active material layer 20B. Specific examples of the carbon material include graphite, carbon black, acetylene black, and Ketjen black.

The secondary battery operates as described below.

Upon charging, the lithium ion is extracted from the positive electrode 20, and a cation such as the extracted lithium ion is inserted into the negative electrode 30 via the electrolytic solution 40. Upon discharging, the cation such as the lithium ion is extracted from the negative electrode 30, and the extracted lithium ion is inserted into the positive electrode 20 via the electrolytic solution 40.

To fabricate the secondary battery, the positive electrode 20 and the negative electrode 30 are each fabricated and the electrolytic solution 40 is prepared, following which the secondary battery is assembled, in accordance with an example procedure described below.

First, the positive electrode active material (the lithium-containing compound), the positive electrode binder (the water-insoluble polar polymer compound), and the positive electrode conductor are mixed with each other to thereby obtain a positive electrode mixture. Thereafter, the positive electrode mixture is put into a solvent to thereby prepare a positive electrode mixture slurry in paste form. The solvent may be an aqueous solvent, or may be an organic solvent. Thereafter, the positive electrode mixture slurry is applied on the two opposed surfaces of the positive electrode current collector 20A (excluding the coupling terminal part 20AT) to thereby form the positive electrode active material layers 20B. Lastly, the positive electrode active material layers 20B are compression-molded by means of, for example, a roll pressing machine. The compression-molding conditions including, without limitation, a pressing pressure and a pressing time may be set as desired. In this case, the positive electrode active material layers 20B may be heated. The positive electrode active material layers 20B may be compression-molded multiple times. Thus, the positive electrode 20 is fabricated.

The negative electrode 30 is fabricated by a procedure similar to the fabrication procedure of the positive electrode 20 described above. Specifically, a negative electrode mixture in which the negative electrode active material, the negative electrode binder, and the negative positive electrode conductor are mixed with each other is put into a solvent to thereby prepare a negative electrode mixture slurry in paste form. Thereafter, the negative electrode mixture slurry is applied on the two opposed surfaces of the negative electrode current collector 30A (excluding the coupling terminal part 30AT) to thereby form the negative electrode active material layers 30B, following which the negative electrode active material layers 30B are compression-molded. Thus, the negative electrode 30 is fabricated.

The ionic material is added to the aqueous solvent. The ionic material is thereby dispersed or dissolved in the aqueous solvent. As a result, the electrolytic solution 40 is prepared. In this case, adjusting conditions including, without limitation, a kind and a concentration (mol/kg) of the ionic material makes it possible to adjust the pH of the electrolytic solution 40.

The positive electrode 20 and the negative electrode 30 are placed into the internal space S of the outer package body 10. In this case, the coupling terminal parts 20AT and 30AT are each led from the inside (the internal space S) to the outside of the outer package body 10.

Thereafter, the electrolytic solution 40 is supplied into the internal space S through an unillustrated injection hole provided in the outer package body 10, and the injection hole is sealed.

Thus, the electrolytic solution 40 is contained in the internal space S in which the positive electrode 20 and the negative electrode 30 are each disposed. As a result, the secondary battery of the one-component type including one aqueous electrolytic solution (the electrolytic solution 40) is completed.

According to the secondary battery of the first embodiment, the positive electrode active material layer 20B includes the positive electrode active material (the lithium-containing compound) and the positive electrode binder (the water-insoluble polar polymer compound), and the electrolytic solution includes the aqueous solvent. Further, the water solubility of the water-insoluble polar polymer compound is less than or equal to 1 g, and the density ratio of the positive electrode active material layer 20B is within the range from 30% to 70% both inclusive.

In this case, the positive electrode binder includes the water-insoluble polar polymer compound. This makes it easier to maintain the structure of the positive electrode active material layer 20B upon charging and discharging, and makes it easier for the charging and discharging reactions to proceed stably in the positive electrode active material layer 20B even when the electrolytic solution 40 that is an aqueous electrolytic solution is used, as described above.

Further, the water solubility of the water-insoluble polar polymer compound is less than or equal to 1 g. This secures the physical strength of the positive electrode active material layer 20B as described above. This facilitates stable and continuous insertion and extraction of the lithium ion into and from the positive electrode active material layer 20B even upon repeated charging and discharging.

Further, the density ratio of the positive electrode active material layer 20B is within the range from 30% to 70% both inclusive. This makes it easier for the electrolytic solution 40 to permeate into the positive electrode active material layer 20B even when the electrolytic solution 40 that is an aqueous electrolytic solution is used, as described above. This further facilitates stable and continuous insertion and extraction of the lithium ion into and from the positive electrode active material layer 20B even upon repeated charging and discharging.

Based upon the foregoing, the lithium ion is stably and continuously inserted into and extracted from the positive electrode active material layer 20B even upon repeated charging and discharging, thereby allowing the charging and discharging reactions to proceed stably in the positive electrode active material layer 20B. This makes it possible to achieve a superior battery characteristic.

In particular, in the first repeating unit and the second repeating unit, the hydrocarbon group for each of R1 and R3 may include the alkyl group having carbon number from 1 to 10 both inclusive, and the hydrocarbon group for R2 may include the alkyl group having carbon number of 1 or 2. This allows the water-insoluble polar polymer compound to have sufficient solubility and sufficient compatibility. This allows the positive electrode active material layer 20B to have a sufficient binding property. It is thus possible to achieve higher effects.

Further, the positive electrode 20 may include the positive electrode current collector 20A, and the positive electrode current collector 20A may include titanium as a constituent element. This suppresses degradation of the positive electrode current collector 20A upon charging and discharging. Accordingly, it is possible to achieve higher effects.

Further, the lithium-containing compound may include the lithium composite oxide, and the lithium composite oxide may have the spinel crystal structure and include manganese as a constituent element. This improves the charging efficiency and the discharging efficiency. Accordingly, it is possible to achieve higher effects.

It is possible to achieve the effects described above similarly also when the lithium-containing compound includes the lithium phosphoric acid compound, and the lithium phosphoric acid compound has the olivine crystal structure and includes iron as a constituent element.

Further, the positive electrode active material layer 20B may include the positive electrode conductor, and the positive electrode conductor may include the carbon material. This improves the electrical conductivity of the positive electrode active material layer 20B. Accordingly, it is possible to achieve higher effects.

Further, the pH of the electrolytic solution 40 may be less than 11. This makes it easier for the charging and discharging reactions to proceed. Accordingly, it is possible to achieve higher effects.

A description is given next of a secondary battery according to a second embodiment of the present technology.

The secondary battery according to the second embodiment is a secondary battery of a two-component type including two aqueous electrolytic solutions, i.e., a positive electrode electrolytic solution 61 and a negative electrode electrolytic solution 62, unlike the secondary battery according to the first embodiment, which is the secondary battery of the one-component type including one aqueous electrolytic solution (the electrolytic solution 40).

FIG. 2 illustrates a sectional configuration of the secondary battery according to the second embodiment, and corresponds to FIG. 1. The secondary battery according to the second embodiment to be described here has a configuration similar to the configuration (FIG. 1) of the secondary battery according to the first embodiment except for those described below.

As illustrated in FIG. 2, the secondary battery further includes a partition 50, and includes the positive electrode electrolytic solution 61 and the negative electrode electrolytic solution 62 in place of the electrolytic solution 40. In FIG. 2, the positive electrode electrolytic solution 61 is lightly shaded, and the negative electrode electrolytic solution 62 is darkly shaded.

The outer package body 10 has two spaces that are separated from each other by the partition 50. The two spaces are a positive electrode compartment S1 and a negative electrode compartment S2.

The partition 50 is disposed between the positive electrode 20 and the negative electrode 30, and divides the internal space S (see FIG. 1) into the positive electrode compartment S1 and the negative electrode compartment S2. Accordingly, the positive electrode 20 and the negative electrode 30 are separated from each other with the partition 50 interposed therebetween, and are opposed to each other with the partition 50 interposed therebetween.

The partition 50 does not allow an anion to pass therethrough and allows a substance such as the lithium ion (a cation) other than the anion, which is to be inserted into and extracted from each of the positive electrode 20 and the negative electrode 30, to pass therethrough, between the positive electrode compartment S1 and the negative electrode compartment S2. One reason for this is to prevent mixing of the positive electrode electrolytic solution 61 and the negative electrode electrolytic solution 62 with each other. That is, the partition 50 allows the lithium ion to pass therethrough from the positive electrode compartment S1 to the negative electrode compartment S2, and allows the lithium ion to pass therethrough from the negative electrode compartment S2 to the positive electrode compartment S1.

Specifically, the partition 50 includes an ion exchange membrane, a solid electrolyte membrane, or both. One reason for this is that permeability of the partition 50 to the lithium ion improves. The ion exchange membrane is a porous film that allows the lithium ion to pass therethrough, i.e., a positive ion exchange membrane. The solid electrolyte membrane has lithium-ion conductivity.

Note that the solid electrolyte membrane may be what is called an inorganic particle film. The inorganic particle film is a composite film including inorganic particles, a binder, and a fibrous substance. The inorganic particles have lithium io conductivity. The inorganic particles include any one or more of inorganic materials including, without limitation, an oxide, a sulfide, a hydroxide, a carbonic acid salt, and a sulfuric acid salt. The binder includes any one or more of polymer compounds including, without limitation, polyvinyl formal, polyvinyl alcohol, polyvinyl acetal, polyvinyl butyral, polymethyl methacrylate, and polytetrafluoroethylene. The fibrous substance includes any one or more of cellulose fibers, a polysaccharide, polyvinyl alcohol, polyacrylic acid, an anionic derivative of polystyrene, and a cationic derivative of polystyrene.

In particular, the partition 50 preferably includes the ion exchange membrane rather than the solid electrolyte membrane. One reason for this is that this makes it easier for an aqueous solvent in the positive electrode electrolytic solution 61 to permeate into the partition 50, and makes it easier for an aqueous solvent in the negative electrode electrolytic solution 62 to permeate into the partition 50. This improves lithium-ion conductivity inside the partition 50.

The positive electrode 20 is contained inside the positive electrode compartment S1, and allows the lithium ion to be inserted thereinto and extracted therefrom. The negative electrode 30 is contained inside the negative electrode compartment S2, and allows the lithium ion to be inserted thereinto and extracted therefrom.

The positive electrode electrolytic solution 61 and the negative electrode electrolytic solution 62 are each the aqueous electrolytic solution. The positive electrode electrolytic solution 61 is contained inside the positive electrode compartment S1, and the negative electrode electrolytic solution 62 is contained inside the negative electrode compartment S2. The positive electrode electrolytic solution 61 and the negative electrode electrolytic solution 62 are therefore so separated from each other with the partition 50 interposed therebetween as not to be mixed with each other.

Thus, the positive electrode electrolytic solution 61 contained inside the positive electrode compartment S1 is in contact with only the positive electrode 20 and not in contact with the negative electrode 30. In contrast, the negative electrode electrolytic solution 62 contained inside the negative electrode compartment S2 is in contact with only the negative electrode 30 and not in contact with the positive electrode 20.

A pH of the positive electrode electrolytic solution 61 and a pH of the negative electrode electrolytic solution 62 are different from each other. Specifically, the pH of the negative electrode electrolytic solution 62 is higher than the pH of the positive electrode electrolytic solution 61. As long as such a high-and-low relationship related to the pH is satisfied, a composition (e.g., a kind of the aqueous solvent and a kind and a concentration of an ionic material) of each of the positive electrode electrolytic solution 61 and the negative electrode electrolytic solution 62 may be set as desired.

One reason why the pH of the negative electrode electrolytic solution 62 is higher than the pH of the positive electrode electrolytic solution 61 is that a decomposition potential of the aqueous solvent shifts owing to a difference between the pHs of the two electrolytic solutions. This widens a potential window of the aqueous solvent while thermodynamically suppressing a decomposition reaction of the aqueous solvent upon charging and discharging. Accordingly, it is easier for the charging and discharging reactions through insertion and extraction of the lithium ion to proceed sufficiently and stably while a high voltage is obtained.

In particular, it is preferable that a composition formula (a kind of an electrolyte salt) of the positive electrode electrolytic solution 61 and a composition formula (a kind of an electrolyte salt) of the negative electrode electrolytic solution 62 be different from each other. One reason for this is that this makes it easier to secure the above-described high-and-low relationship related to the pH.

As long as the above-described high-and-low relationship related to the pH is satisfied, the value of the pH of each of the positive electrode electrolytic solution 61 and the negative electrode electrolytic solution 62 is not particularly limited.

In particular, the negative electrode electrolytic solution 62 that is in contact with the negative electrode 30 preferably has a pH that is higher than or equal to 11. The pH of the negative electrode electrolytic solution 62 is more preferably higher than or equal to 12, and still more preferably higher than or equal to 13. One reason for this is that this allows the negative electrode electrolytic solution 62 to have a sufficiently high pH, therefore making it even easier to secure the high-and-low relationship related to the pH described above. Another reason is that this provides a sufficiently large difference between the pH of the positive electrode electrolytic solution 61 and the pH of the negative electrode electrolytic solution 62, therefore making it easier to maintain the high-and-low relationship between the pHs of the two electrolytic solutions.

The positive electrode electrolytic solution 61 that is in contact with the positive electrode 20 preferably has a pH lower than 11. Specifically, the pH of the positive electrode electrolytic solution 61 is preferably within a range from 3 to 8 both inclusive, more preferably within a range from 4 to 8 both inclusive, and still more preferably within a range from 4 to 6 both inclusive. One reason for this is that this allows the positive electrode electrolytic solution 61 to have a sufficiently low pH, therefore making it even easier to secure the high-and-low relationship related to the pH, and making it easier to maintain the high-and-low relationship. Another reason is that this suppresses corrosion of, for example, the outer package body 10, the positive electrode current collector 20A, and the negative electrode current collector 30A, therefore improving electrochemical durability or stability of the secondary battery.

Note that the positive electrode electrolytic solution 61, the negative electrode electrolytic solution 62, or each of the positive electrode electrolytic solution 61 and the negative electrode electrolytic solution 62 is preferably a saturated solution of the electrolyte salt (a lithium salt), as with the electrolytic solution 40 according to the first embodiment. One reason for this is that this makes it easier for the charging and discharging reactions to proceed stably upon charging and discharging. A method of checking whether the positive electrode electrolytic solution 61 and the negative electrode electrolytic solution 62 are each the saturated solution of the lithium salt is similar to a method of checking whether the electrolytic solution 40 is the saturated solution of the lithium salt.

Further, the positive electrode electrolytic solution 61 and the negative electrode electrolytic solution 62 may each be a pH buffer solution. The pH buffer solution may be an aqueous solution in which a weak acid and a conjugate base thereof are mixed together, or an aqueous solution in which a weak base and a conjugate acid thereof are mixed together. One reason for this is that this sufficiently suppresses variation in pH, and therefore makes it easier to maintain each of the pH of the positive electrode electrolytic solution and the pH of the negative electrode electrolytic solution 62.

In particular, the positive electrode electrolytic solution 61 preferably includes, as one or more anions, any one or more of ions including, without limitation, a sulfuric acid ion, a hydrogen sulfuric acid ion, a carbonic acid ion, a hydrogen carbonic acid ion, a phosphoric acid ion, a monohydrogen phosphoric acid ion, a dihydrogen phosphoric acid ion, and a carboxylic acid ion. One reason for this is that this sufficiently suppresses variation in pH of the positive electrode electrolytic solution 61, therefore making it easier to sufficiently maintain the pH of the positive electrode electrolytic solution 61. Specific examples of the carboxylic acid ion include a formic acid ion, an acetic acid ion, a propionic acid ion, a tartaric acid ion, and a citric acid ion.

Note that the pH of the positive electrode electrolytic solution 61 and the negative electrode electrolytic solution 62 may each include any one or more of materials including, without limitation, tris(hydroxymethyl)aminomethane and ethylenediaminetetraacetic acid as one or more buffers.

More specifically, it is preferable that the positive electrode electrolytic solution 61 include any one or more of a sulfuric acid ion, a hydrogen sulfuric acid ion, a carbonic acid ion, a hydrogen carbonic acid ion, a phosphoric acid ion, a monohydrogen phosphoric acid ion, or a dihydrogen phosphoric acid ion as one or more anions, and the negative electrode electrolytic solution 62 include a hydroxide ion as an anion. One reason for this is that this makes it easier to control the pH of the positive electrode electrolytic solution 61 to be sufficiently high and to control the pH of the negative electrode electrolytic solution 62 to be sufficiently low.

Here, the positive electrode electrolytic solution 61 and the negative electrode electrolytic solution 62 are preferably isotonic solutions that are isotonic with each other. One reason for this is that this makes osmotic pressure of each of the positive electrode electrolytic solution 61 and the negative electrode electrolytic solution 62 appropriate, and therefore makes it easier to maintain the high-and-low relationship between the pHs of the two electrolytic solutions.

The secondary battery operates as described below.

Upon charging, the lithium ion is extracted from the positive electrode 20, and a cation such as the extracted lithium ion is inserted into the negative electrode 30 via the positive electrode electrolytic solution 61, the partition 50, and the negative electrode electrolytic solution 62.

Upon discharging, the cation such as the lithium ion is extracted from the negative electrode 30, and the extracted lithium ion is inserted into the positive electrode 20 via the negative electrode electrolytic solution 62, the partition 50, and the positive electrode electrolytic solution 61.

A procedure for manufacturing the secondary battery is similar to the above-described procedure for manufacturing the secondary battery according to the first embodiment except for those described below.

To prepare each of the positive electrode electrolytic solution 61 and the negative electrode electrolytic solution 62, the ionic material is added to the aqueous solvent. In this case, conditions including, without limitation, the kind and the concentration (mol/kg) of the ionic material are adjusted to thereby set the pH of the negative electrode electrolytic solution 62 to be higher than the pH of the positive electrode electrolytic solution 61.

To assemble the secondary battery, first, the outer package body 10 to which the partition 50 is attached in advance is prepared. The outer package body 10 has the positive electrode compartment S1 and the negative electrode compartment S2. Thereafter, the positive electrode 20 is placed inside the positive electrode compartment S1, and the coupling terminal part 20AT is led from an inside to an outside of the positive electrode compartment S1. Further, the negative electrode 30 is placed inside the negative electrode compartment S2, and the coupling terminal part 30AT is led from an inside to an outside of the negative electrode compartment S2. Lastly, the positive electrode electrolytic solution 61 is supplied into the positive electrode compartment S1 through an unillustrated positive electrode injection hole that is provided in the outer package body 10, and the negative electrode electrolytic solution 62 is supplied into the negative electrode compartment S2 through an unillustrated negative electrode injection hole that is provided in the outer package body 10. Thereafter, the positive electrode injection hole and the negative electrode injection hole are each sealed.

Thus, the positive electrode electrolytic solution 61 is contained inside the positive electrode compartment S1 in which the positive electrode 20 is contained, and the negative electrode electrolytic solution 62 is contained inside the negative electrode compartment S2 in which the negative electrode 30 is contained. As a result, the secondary battery of the two-component type including two aqueous electrolytic solutions (the positive electrode electrolytic solution 61 and the negative electrode electrolytic solution 62) is completed.

The secondary battery according to the second embodiment has a configuration similar to the configuration of the secondary battery according to the first embodiment described above, except that the positive electrode electrolytic solution 61 and the negative electrode electrolytic solution 62 are included instead of the electrolytic solution 40, and the pH of the negative electrode electrolytic solution 62 is higher than the pH of the positive electrode electrolytic solution 61. Accordingly, it is possible to achieve a superior operation characteristic for a reason similar to the reason described above regarding the secondary battery according to the first embodiment.

In this case, in particular, two aqueous electrolytic solutions (the positive electrode electrolytic solution 61 and the negative electrode electrolytic solution 62) having different pHs from each other are used. Accordingly, it is easier for the charging and discharging reactions through insertion and extraction of the lithium ion to proceed sufficiently and stably while a high voltage is obtained. This makes it possible to achieve an even superior battery characteristic.

Other action and effects related to the secondary battery according to the second embodiment are similar to other action and effects related to the secondary battery according to the first embodiment.

The configuration of the secondary battery is appropriately modifiable as described below according to an embodiment.

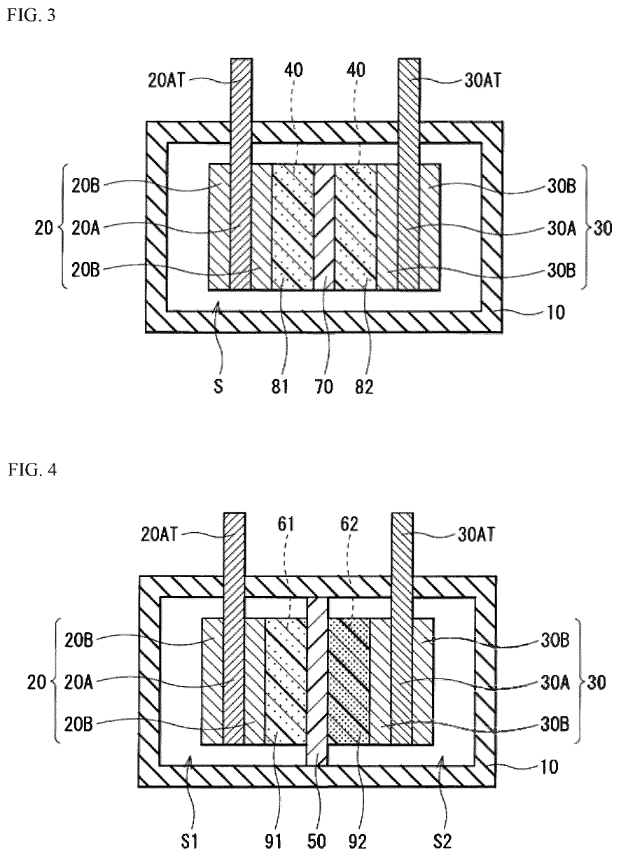

In the first embodiment, the electrolytic solution 40, which is a liquid electrolyte, is used as illustrated in FIG. 1. However, as illustrated in FIG. 3 corresponding to FIG. 1, electrolyte layers 81 and 82 may be used instead of the electrolytic solution 40. The electrolyte layers 81 and 82 are gel electrolytes. A configuration of a secondary battery illustrated in FIG. 3 is similar to the configuration of the secondary battery illustrated in FIG. 1 except for those described below.

Here, the secondary battery further includes a separator 70 and the above-described electrolyte layers 81 and 82. The separator 70 is disposed between the positive electrode 20 and the negative electrode 30. The electrolyte layer 81 is disposed between the positive electrode 20 and the separator 70, and the electrolyte layer 82 is disposed between the negative electrode 30 and the separator 70. Thus, the electrolyte layer 81 is adjacent to each of the positive electrode 20 and the separator 70, and the electrolyte layer 82 is adjacent to each of the negative electrode 30 and the separator 70.

The electrolyte layers 81 and 82 each include the electrolytic solution 40 and a polymer compound, and the electrolytic solution 40 is held by the polymer compound. The polymer compound is not particularly limited in kind, and specifically includes any one or more of materials including, without limitation, polyvinylidene difluoride and polyethylene oxide. In FIG. 3, the electrolyte layers 81 and 82 are each lightly shaded.

The separator 70 is an insulating porous film that allows the lithium ion to pass therethrough and separates the electrolyte layers 81 and 82 from each other. The separator 70 includes a polymer compound such as polyethylene.

To form the electrolyte layer 81, the electrolytic solution 40, the polymer compound, and a solvent for dilution are mixed with each other to thereby prepare a precursor solution in a sol form, following which the precursor solution is applied on the surface of the positive electrode 20. A procedure for forming the electrolyte layer 82 is similar to the procedure for forming the electrolyte layer 81 except that the precursor solution is applied on the surface of the negative electrode 30.

In this case also, the lithium ion is movable between the positive electrode 20 and the negative electrode 30 via the electrolyte layers 81 and 82. Accordingly, it is possible to achieve effects similar to those of the case illustrated in FIG. 1. In this case, it is possible to prevent leakage of the electrolytic solution in particular.

In the second embodiment, the positive electrode electrolytic solution 61 and the negative electrode electrolytic solution 62, which are liquid electrolytes, are used as illustrated in FIG. 2. However, as illustrated in FIG. 4 corresponding to FIG. 2, electrolyte layers 91 and 92 may be used instead of the positive electrode electrolytic solution 61 and the negative electrode electrolytic solution 62. The electrolyte layers 91 and 92 are gel electrolytes. A configuration of a secondary battery illustrated in FIG. 4 is similar to the configuration of the secondary battery illustrated in FIG. 2 except for those described below.

Here, the secondary battery further includes the above-described electrolyte layers 91 and 92. The electrolyte layer 91 is disposed between the positive electrode 20 and the partition 50, and the electrolyte layer 92 is disposed between the negative electrode 30 and the partition 50. Thus, the electrolyte layer 91 is adjacent to each of the positive electrode 20 and the partition 50, and the electrolyte layer 92 is adjacent to each of the negative electrode 30 and the partition 50.

The electrolyte layer 91 includes the positive electrode electrolytic solution 61 and a polymer compound, and the positive electrode electrolytic solution 61 is held by the polymer compound. The electrolyte layer 92 includes the negative electrode electrolytic solution 62 and a polymer compound, and the negative electrode electrolytic solution 62 is held by the polymer compound. Details of the kinds of the polymer compound are as described above. In FIG. 4, the electrolyte layer 91 including the positive electrode electrolytic solution 61 is lightly shaded, and the electrolyte layer 92 including the negative electrode electrolytic solution 62 is darkly shaded.

To form the electrolyte layer 91, the positive electrode electrolytic solution 61, the polymer compound, and a solvent for dilution are mixed with each other to thereby prepare a precursor solution in a sol form, following which the precursor solution is applied on the surface of the positive electrode 20. To form the electrolyte layer 92, the negative electrode electrolytic solution 62, the polymer compound, and a solvent for dilution are mixed with each other to thereby prepare a precursor solution in a sol form, following which the precursor solution is applied on the surface of the negative electrode 30.

In this case also, the lithium ion is movable between the positive electrode 20 and the negative electrode 30 via the electrolyte layers 91 and 92. Accordingly, it is possible to achieve effects similar to those of the case illustrated in FIG. 2. In this case, it is possible to prevent leakage of the electrolytic solution in particular.

Applications (application examples) of the secondary battery are not particularly limited. The secondary battery used as a power source may serve as a main power source or an auxiliary power source in, for example, electronic equipment and an electric vehicle. The main power source is preferentially used regardless of the presence of any other power source. The auxiliary power source is used in place of the main power source, or is switched from the main power source.

Specific examples of the applications of the secondary battery include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include battery systems for home use or industrial use in which electric power is accumulated for a situation such as emergency. In each of the above-described applications, one secondary battery may be used, or multiple secondary batteries may be used.

The battery packs may each include a battery cell, or may each include an assembled battery. The electric vehicle is a vehicle that operates (travels) with the secondary battery as a driving power source, and may be a hybrid automobile that is additionally provided with a driving source other than the secondary battery. In an electric power storage system for home use, electric power accumulated in the secondary battery that is an electric power storage source may be utilized for using, for example, home appliances.

Needless to say, the secondary battery may have applications other than the series of applications described here as examples.

### EXAMPLES

A description is given of Examples of the present technology according to an embodiment.

### Examples 1 to 13 and Comparative Examples 1 to 9

Secondary batteries were manufactured, following which the secondary batteries were each evaluated for a battery characteristic, as described below.

### [Fabrication of Electrochemical Measurement Cell]

For simple evaluation of the battery characteristic, an electrochemical measurement cell having a configuration substantially similar to that of the secondary battery of the one-component type (FIG. 1) described in the first embodiment was fabricated in accordance with the following procedure.

### [Fabrication of Positive Electrode]

First, a positive electrode active material, a positive electrode binder, and a positive electrode conductor (carbon black as a carbon material) were mixed with each other to thereby obtain a positive electrode mixture.

As the positive electrode active material, used were a lithium composite oxide (LiMn₂O₄ (LMO)) having a spinel crystal structure and including manganese as a constituent element, and a lithium phosphoric acid compound (LiFePO₄ (LFP)) having an olivine crystal structure and including iron as a constituent element.

As the positive electrode binder, used were poly(methyl acrylate) (PAM) as a water-insoluble polar polymer compound including the first repeating unit (where R1 is a methyl group and R2 is a hydrogen group), and polyvinyl butyral (PVB) as a water-insoluble polar polymer compound including the second repeating unit (where R3 is an n-propyl group). A water solubility (g) and a weight average molecular weight of each of the water-insoluble polar polymer compounds were as listed in Tables 1 to 3.

To obtain the positive electrode mixture, a mixture ratio (a weight ratio) was changed as described below. The mixture ratio of the positive electrode active material was changed within a range from 70 parts by mass to 94 parts by mass both inclusive. The mixture ratio of the positive electrode binder was changed within a range from 3 parts by mass to 20 parts by mass both inclusive. The mixture ratio of the positive electrode conductor was changed within a range from 3 parts by mass to 10 parts by mass both inclusive.

Thereafter, the positive electrode mixture was put into a solvent (N-methyl-2-pyrrolidone as an organic solvent), following which the organic solvent was stirred to thereby prepare a positive electrode mixture slurry in paste form. Thereafter, the positive electrode mixture slurry was applied on the two opposed surfaces of the positive electrode current collector 20A (excluding the coupling terminal part 20AT) by means of a coating apparatus, following which the applied positive electrode mixture slurry was dried to thereby form the positive electrode active material layers 20B.

As the positive electrode current collector 20A, used were a meshed titanium foil (Ti) having a thickness of 200 μm and a meshed nickel foil (Ni) having a thickness of 200 μm.

Lastly, the positive electrode active material layers 20B were compression-molded by means of a pressing machine. The positive electrode 20 was thus fabricated (Examples 1 to 13 and Comparative examples 3, 4, and 6 to 8).

The density ratio (%) was as listed in Tables 1 to 3. In this case, compression-molding conditions (a pressing pressure and a pressing time) for the positive electrode active material layer 20B were changed to thereby change the density ratio with change in volume density.

Note that the positive electrode 20 for comparison was fabricated by a similar procedure except that another polymer compound was used as the positive electrode binder instead of the water-insoluble polar polymer compound. As the other polymer compound, used were polyvinylidene difluoride (PVDF), carboxymethyl cellulose (CMC), and a polyacrylic acid (PAA) (Comparative examples 1, 2, 5, and 9). A water solubility (g) and a weight average molecular weight of each of the other polymer compounds were as listed in Table 3.

### [Fabrication of Negative Electrode]

A meshed nickel foil having a thickness of 200 μm was used as the negative electrode 30.

### [Preparation of Electrolytic Solution]

An ionic material (lithium sulfate as an electrolyte salt) was put into a solvent (water as an aqueous solvent), following which the solvent was stirred to thereby prepare the electrolytic solution 40 as an aqueous electrolytic solution. In this case, a concentration of the electrolytic solution 40 was 2 mol/kg, and a pH of the electrolytic solution 40 was 4.

### [Assembly of Electrochemical Measurement Cell]

First, the positive electrode 20 and the negative electrode 30 were each placed in the internal space S of the outer package body 10 including glass (a glass beaker). In this case, the coupling terminal part 20AT was led from the inside to the outside of the outer package body 10, and a part of the negative electrode 30 was led from the inside to the outside of the outer package body 10. Thereafter, a reference electrode (an unillustrated silver-silver chloride electrode) was disposed in the internal space S. Lastly, the electrolytic solution 40 was supplied into the internal space S. Thus, the electrolytic solution 40 was contained in the internal space S. As a result, the electrochemical measurement cell was completed.

### [Evaluation of Battery Characteristic]

The secondary batteries were each evaluated for each of a discharge characteristic and a cyclability characteristic as the battery characteristic in accordance with the following procedure, which revealed the results presented in Tables 1 to 3.

### [Discharge Characteristic]

The electrochemical measurement cell was charged and discharged in an ambient temperature environment (at a temperature of 23° C.) to thereby calculate a discharge capacity (mAh/g) as an index for evaluating the discharge characteristic. The discharge capacity was a discharge capacity (mAh) per weight (g) of the positive electrode active material.

Upon the charging, the electrochemical measurement cell was charged with a constant current of 1 C until a voltage reached −1.45 V with respect to the reference electrode (silver-silver chloride), and was thereafter charged with a constant voltage of −1.45 V until a current reached 0.5 C. Upon the discharging, the electrochemical measurement cell was discharged with a constant current of 1 C until the voltage reached −1.00 V with respect to the reference electrode. Note that 1 C was a value of a current that caused a battery capacity (a theoretical capacity) to be completely discharged in 1 hour, and 0.5 C was a value of a current that caused the battery capacity to be completely discharged in 2 hours.

### [Cyclability Characteristic]

First, the secondary battery was charged and discharged in an ambient temperature environment to thereby measure a discharge capacity (a first-cycle discharge capacity). Charging and discharging conditions were similar to the charging and discharging conditions for evaluation of the discharge characteristic described above.

Thereafter, the secondary battery was repeatedly charged and discharged in the same environment until the total number of cycles reached 20 to thereby measure the discharge capacity (a 20th-cycle discharge capacity). Charging and discharging conditions were similar to the charging and discharging conditions for evaluation of the discharge characteristic described above.

Lastly, a capacity retention rate as an index for evaluating the cyclability characteristic was calculated based on the following calculation expression: capacity retention rate (%)=(20th-cycle discharge capacity/first-cycle discharge capacity)×100.

Note that as presented in Table 3, the capacity retention rate was not calculated when it was not possible to charge and discharge the secondary battery (Comparative examples 3 and 6) and when the secondary battery was charged and discharged, but the discharge capacity markedly decreased (Comparative examples 4 and 7).

TABLE 1

| | | Positive electrode active material layer | | | | | | | |
|---|---|---|---|---|---|---|---|---|---|
| | Positive | Positive | Positive electrode binder | | | | | | |
| | electrode | electrode | | | | Weight | | | |
| | current | active | | | Water | average | Density | Discharge | Capacity |
| | collector | material | | Repeating | solubility | molecular | ratio | capacity | retention |
| | Material | Kind | Kind | unit | (g) | weight | (%) | (mAh/g) | rate (%) |
| Example 1 | Ti | LMO | PAM | First | <0.1 | 100000 | 30 | 98 | 65 |
| Example 2 | Ti | LMO | PAM | First | <0.1 | 100000 | 50 | 98 | 85 |
| Example 3 | Ti | LMO | PAM | First | <0.1 | 100000 | 60 | 100 | 88 |
| Example 4 | Ti | LMO | PAM | First | <0.1 | 100000 | 70 | 95 | 82 |
| Example 5 | Ti | LMO | PAM | First | <0.1 | 300000 | 50 | 85 | 87 |
| Example 6 | Ni | LMO | PAM | First | <0.1 | 100000 | 50 | 92 | 70 |
| Example 7 | Ti | LFP | PAM | First | <0.1 | 100000 | 30 | 138 | 72 |
| Example 8 | Ti | LFP | PAM | First | <0.1 | 100000 | 60 | 141 | 92 |
| Example 9 | Ti | LFP | PAM | First | <0.1 | 100000 | 70 | 140 | 89 |

TABLE 2

| | | Positive electrode active material layer | | | | | | | |
|---|---|---|---|---|---|---|---|---|---|
| | Positive | Positive | Positive electrode binder | | | | | | |
| | electrode | electrode | | | | Weight | | | |
| | current | active | | | Water | average | Density | Discharge | Capacity |
| | collector | material | | Repeating | solubility | molecular | ratio R | capacity | retention |
| | Material | Kind | Kind | unit | (g) | weight | (%) | (mAh/g) | rate (%) |
| Example 10 | Ti | LMO | PVB | Second | <0.1 | 100000 | 30 | 65 | 73 |
| Example 11 | Ti | LMO | PVB | Second | <0.1 | 100000 | 50 | 78 | 83 |
| Example 12 | Ti | LMO | PVB | Second | <0.1 | 100000 | 70 | 76 | 78 |
| Example 13 | Ti | LFP | PVB | Second | <0.1 | 100000 | 60 | 120 | 82 |

TABLE 3

| | | Positive electrode active material layer | | | | | | | |
|---|---|---|---|---|---|---|---|---|---|
| | Positive | Positive | Positive electrode binder | | | | | | |
| | electrode | electrode | | | | Weight | | | Capacity |
| | current | active | | | Water | average | Density | Discharge | retention |
| | collector | material | | Repeating | solubility | molecular | ratio R | capacity | rate |
| | Material | Kind | Kind | unit | (g) | weight | (%) | (mAh/g) | (%) |
| Comparative example 1 | Ti | LMO | PVDF | — | <0.1 | 100000 | 50 | 55 | 70 |
| Comparative example 2 | Ti | LMO | CMC | — | >3 | 100000 | 50 | 92 | 5 |
| Comparative example 3 | Ti | LMO | PAM | First | <0.1 | 100000 | 10 | 0 | — |
| Comparative example 4 | Ti | LMO | PAM | First | <0.1 | 100000 | 81 | 20 | — |
| Comparative example 5 | Ti | LMO | PAA | First | >20 | 100000 | 50 | 85 | 10 |
| Comparative example 6 | Ti | LMO | PVB | Second | <0.1 | 100000 | 10 | 0 | — |
| Comparative example 7 | Ti | LMO | PVB | Second | <0.1 | 100000 | 81 | 18 | — |
| Comparative example 8 | Ti | LMO | PVB | Second | >20 | 100000 | 50 | 78 | 25 |
| Comparative example 9 | Ti | LFP | PVDF | — | <0.1 | 100000 | 60 | 45 | 71 |

As indicated in Tables 1 to 3, in the electrochemical measurement cell including the aqueous electrolytic solution (the electrolytic solution 40), the discharge capacity and the capacity retention rate each varied depending on the configuration of the positive electrode 20.

Specifically, when two conditions were not satisfied that the positive electrode binder included the water-insoluble polar polymer compound having a water solubility less than or equal to 1 g and the density ratio was within a range from 30% to 70% both inclusive (Comparative examples 1 to 9), it was not possible to charge and discharge the secondary battery basically, or even when the secondary battery was charged and discharged, the discharge capacity, the capacity retention rate, or both decreased.

In contrast, when the two conditions were satisfied that the positive electrode binder included the water-insoluble polar polymer compound having a water solubility less than or equal to 1 g and that the density ratio was within the range from 30% to 70% both inclusive (Examples 1 to 13), the discharge capacity increased, and the capacity retention rate also increased.

In this case (Examples 1 to 13), the following tendencies were obtained in particular.

Firstly, even when the weight average molecular weight of the water-insoluble polar polymer compound was changed, a high discharge capacity was obtained, and a high capacity retention rate was also obtained.

Secondly, when the positive electrode current collector 20A included titanium as a constituent element, the discharge capacity further increased, and the capacity retention rate also further increased.

Thirdly, when the positive electrode active material included the lithium composite oxide (LMO) or the lithium phosphoric acid compound (LFP), a high discharge capacity was obtained, and a high capacity retention rate was also obtained.

Fourthly, when the positive electrode active material layer 20B included the positive electrode conductor (the carbon material), a high discharge capacity was obtained, and a high capacity retention rate was also obtained.

Fifthly, when the pH of the electrolytic solution 40 was less than 11, a high discharge capacity was obtained, and a high capacity retention rate was also obtained.

Note that only the secondary battery (the electrochemical measurement cell) of the one-component type described in the first embodiment was checked specifically. However, the results presented in Table 1 suggest that similar tendencies will be obtained also when the secondary battery of the two-component type described in the second embodiment is checked.

Based upon the results presented in Table 1, when: in the secondary battery including the aqueous electrolytic solution (the electrolytic solution 40), the positive electrode active material layer 20B included the positive electrode active material (the lithium-containing compound) and the positive electrode binder (the water-insoluble polar polymer compound); the water solubility of the water-insoluble polar polymer compound was less than or equal to 1 g; and the density ratio of the positive electrode active material layer 20B was within the range from 30% to 70% both inclusive, a high discharge capacity was obtained, and a high capacity retention rate was also obtained. Each of the discharge characteristic and the cyclability characteristic therefore improved. Accordingly, the secondary battery achieved a superior battery characteristic.

The configuration of the secondary battery of the present technology has been described above with reference to some embodiments and Examples. However, the configuration of the secondary battery of the present technology is not limited to the configurations described with reference to the embodiments and Examples above, and is modifiable in a variety of ways.

The effects described herein are mere examples, and effects of the present technology are therefore not limited to those described herein. Accordingly, the present technology may achieve other effects.

Note that the present technology may have any of the following configurations.

<1>

A secondary battery including:
a positive electrode including a positive electrode active material layer;
a negative electrode; and
an electrolytic solution including an aqueous solvent, in which
the positive electrode active material layer includes
   a positive electrode active material including a lithium-containing compound which a lithium ion is to be inserted into and extracted from, and
   a positive electrode binder including a polymer compound,
the polymer compound includes a repeating unit represented by Formula (1), a repeating unit represented by Formula (2), or both,
a solubility of the polymer compound in 100 g of water is less than or equal to 1 g, and
a ratio of a volume density of the positive electrode active material layer to a true density of the positive electrode active material is greater than or equal to 30% and less than or equal to 70%,

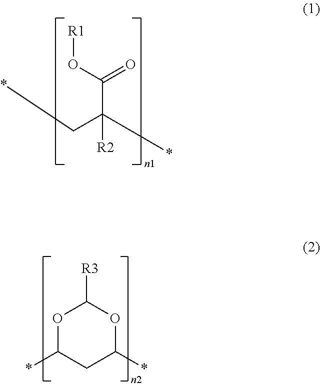

where:
R1 is either a hydrocarbon group or an oxygen-containing hydrocarbon group;
R2 is either a hydrogen group or a hydrocarbon group;
R3 is either a hydrocarbon group or an oxygen-containing hydrocarbon group;
each of n1 and n2 is an integer of 2 or greater; and
an asterisk (*) represents a dangling bond.
   <2>

The secondary battery according to <1>, in which
the hydrocarbon group for each of R1 and R3 includes an alkyl group having carbon number of greater than or equal to 1 and less than or equal to 10, and
the hydrocarbon group for R2 includes an alkyl group having carbon number of 1 or 2.
   <3>

The secondary battery according to <1> or <2>, in which
the positive electrode further includes a positive electrode current collector that supports the positive electrode active material layer, and
the positive electrode current collector includes titanium as a constituent element.
   <4>

The secondary battery according to any one of <1> to <3>, in which
the lithium-containing compound includes
   a lithium composite oxide having a spinel crystal structure and including manganese as a constituent element, or
   a lithium phosphoric acid compound having an olivine crystal structure and including iron as a constituent element.
      <5>

The secondary battery according to any one of <1> to <4>, in which
the positive electrode active material layer further includes a positive electrode conductor, and
the positive electrode conductor includes a carbon material.
   <6>

The secondary battery according to any one of <1> to <5>, in which a pH of the electrolytic solution is less than 11.

<7>

The secondary battery according to any one of <1> to <5>, further including:
a positive electrode compartment inside which the positive electrode is contained,
a negative electrode compartment inside which the negative electrode is contained, and
a partition that is disposed between the positive electrode compartment and the negative electrode compartment and allows the lithium ion to pass through the partition, in which
the electrolytic solution includes
   a positive electrode electrolytic solution contained inside the positive electrode compartment, and
   a negative electrode electrolytic solution contained inside the negative electrode compartment and having a pH higher than a pH of the positive electrode electrolytic solution.

### REFERENCE SIGNS LIST

20 positive electrode
20A positive electrode current collector
21B positive electrode active material layer
30 negative electrode
40 electrolytic solution
50 partition
61 positive electrode electrolytic solution
62 negative electrode electrolytic solution
S1 positive electrode compartment
S2 negative electrode compartment

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode including a positive electrode active material layer;
a negative electrode; and
an electrolytic solution including an aqueous solvent, wherein
the positive electrode active material layer includes
a positive electrode active material including a lithium-containing compound which a lithium ion is to be inserted into and extracted from, and
a positive electrode binder including a polymer compound,
the polymer compound includes a repeating unit represented by Formula (1), or the repeating unit represented by Formula (1) and a repeating unit represented by Formula (2),
a solubility of the polymer compound in 100 grams of water is less than or equal to 1 gram, and
a ratio of a volume density of the positive electrode active material layer to a true density of the positive electrode active material is greater than or equal to 30 percent and less than or equal to 70 percent, 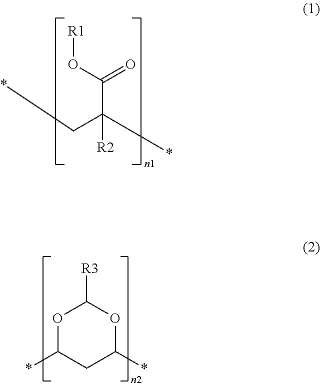
where
R1 is either a hydrocarbon group or an oxygen-containing hydrocarbon group,
R2 is either a hydrogen group or a hydrocarbon group,
R3 is either a hydrocarbon group or an oxygen-containing hydrocarbon group,
each of n1 and n2 is an integer of 2 or greater, and
an asterisk (*) represents a dangling bond.

2. The secondary battery according to claim 1, wherein
the hydrocarbon group for each of R1 and R3 comprises an alkyl group having a carbon number of greater than or equal to 1 and less than or equal to 10, and
the hydrocarbon group for R2 comprises an alkyl group having a carbon number of 1 or 2.

3. The secondary battery according to claim 1, wherein
the positive electrode further includes a positive electrode current collector that supports the positive electrode active material layer, and
the positive electrode current collector includes titanium as a constituent element.

4. The secondary battery according to claim 1, wherein
the lithium-containing compound includes
a lithium composite oxide having a spinel crystal structure and including manganese as a constituent element, or
a lithium phosphoric acid compound having an olivine crystal structure and including iron as a constituent element.

5. The secondary battery according to claim 1, wherein
the positive electrode active material layer further includes a positive electrode conductor, and
the positive electrode conductor includes a carbon material.

6. The secondary battery according to claim 1, wherein a pH of the electrolytic solution is less than 11.

7. The secondary battery according to claim 1, further comprising:
a positive electrode compartment inside which the positive electrode is contained,
a negative electrode compartment inside which the negative electrode is contained, and
a partition that is disposed between the positive electrode compartment and the negative electrode compartment and allows the lithium ion to pass through the partition, wherein
the electrolytic solution includes
a positive electrode electrolytic solution contained inside the positive electrode compartment, and
a negative electrode electrolytic solution contained inside the negative electrode compartment and having a pH higher than a pH of the positive electrode electrolytic solution.
